(19) United States
(12) Patent Application Publication
(10) Pub. No.: US 2024/0085220 A1
(43) Pub. Date: Mar. 14, 2024

(54) DISC SCALE MEMBER OFFSET DETERMINATION

(71) Applicant: RENISHAW PLC, Wotton-under-Edge, Gloucestershire (GB)

(72) Inventors: James Reynolds HENSHAW, Wotton-under-Edge (GB); Matthew Damian HARRISON, Wotton-under-Edge (GB); Ivor John SUMMERS, Wotton-under-Edge (GB)

(73) Assignee: RENISHAW PLC, Wotton-under-Edge, Gloucestershire (GB)

(21) Appl. No.: 18/272,847

(22) PCT Filed: Feb. 8, 2022
(86) PCT No.: PCT/GB2022/050329

§ 371 Date: Jul. 18, 2023

(30) Foreign Application Priority Data
Feb. 9, 2021 (EP) 21275014.5
Oct. 4, 2021 (WO) PCT/GB2021/052562

(51) Int. Cl. G01D 5/347

(52) U.S. Cl. CPC G01D 5/34715; G01D 5/3473

(57) ABSTRACT

A method of determining any offset between: a scale axis of a disc scale member having a planar surface on which is provided a series of scale features defining a scale that extends and is centred around the scale axis, the scale axis extending normal to the planar surface; and the axis of rotation of a machine part on which the disc scale member is mounted, wherein the axis of rotation and the scale axis of the disc scale member are substantially parallel. The method includes: determining any offset between the scale axis and the axis of rotation via inspection of an axially-extending surface provided with the disc scale member.

The present invention relates to a method of determining the offset (e.g. eccentricity) between a scale axis of a disc scale member and the rotation axis of a machine part on which the disc scale member is mounted.

Metrological scales are used in the position measurement of parts of a machine which can move relative to each other. A metrological scale typically has a series of features on it which can be read by a readhead so that the readhead can provide a measure of its position along, or around, the scale. The metrological scale can be mounted onto one part of a machine and is read by a suitable readhead which is attached to the other part of the machine. Known types of metrological scale include magnetic scales (in which the scale features are provided by features having particular magnetic properties), capacitive scales (in which the scale features are provided by features having particular capacitive properties), inductive scales (in which the scale features are provided by features having particular inductive properties) and optical scales (in which the scale features are provided by features having particular optical properties). Optical scales can be transmissive or reflective. Examples of optical scales are disclosed in EP0207121, U.S. Pat. Nos. 4,974,962, 7,499,827 and 7,659,992.

For measuring rotary displacement, such a scale may be provided on a rotary scale member which in use rotates with a shaft or other rotary part on which it is mounted, relative to the readhead. In particular, the rotary scale member can comprise an annular body, in the form of a disc or a ring. Typically, a ring scale member has axially-extending scale features on an outer cylindrical circumferential surface of the annular body, whereas a disc scale member comprises a planar surface on which is provided a series of radially-extending scale features defining a scale that is centred on and extends around a scale axis, the scale axis extending normal to the planar surface and parallel to the axis of rotation. The present invention concerns disc scale members.

Generally, it is desirable to mount a disc scale member (which can also, interchangeably, be referred so as a scale disc member) such that the scale axis is substantially coaxial with the axis of rotation of the part on which it is mounted. This is because any such offset (e.g. eccentricity) between the scale axis and axis of rotation can lead to errors in the signal(s) provided by readhead reading the scale as the disc scale member rotates.

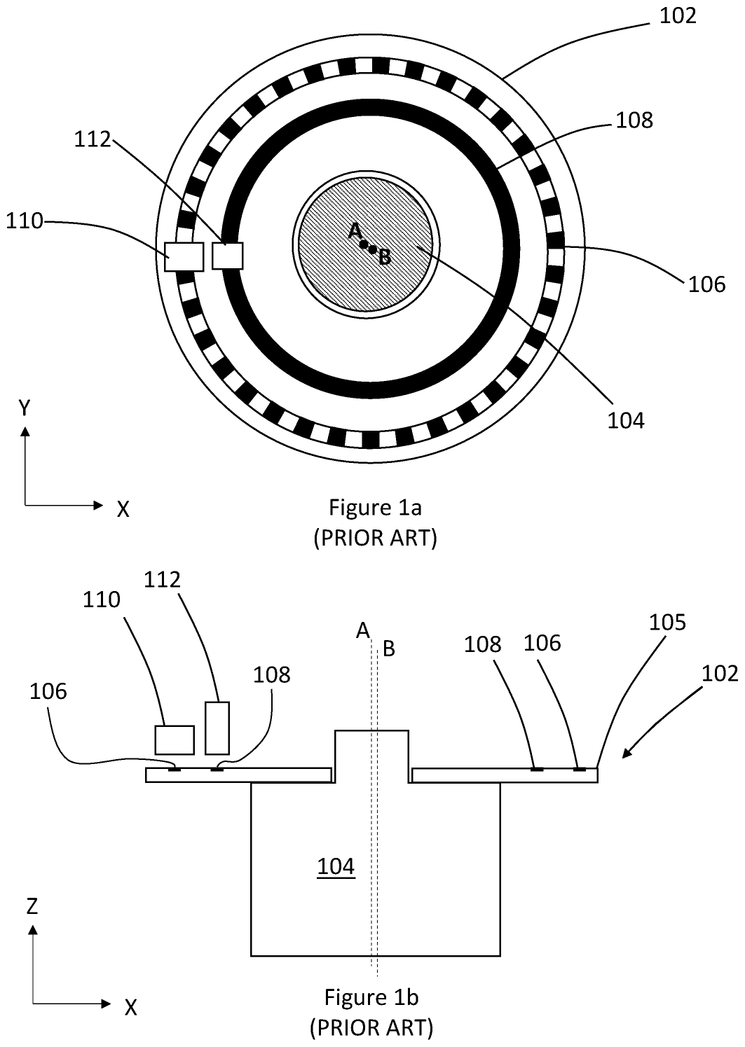

It is therefore known to perform a process of adjusting the radial position of the disc scale member so as to align the scale axis and axis of rotation as best as possible. The act of adjusting the radial position typically involves the use of at least one sensor for providing a measurement which can help to determine the offset between the scale axis and axis of rotation. For example, with reference to FIGS. 1a and 1b, there is shown a disc scale member 102 mounted on a shaft 104. The shaft 104 has an axis of rotation A. The disc scale member 102 comprises a series of scale features 106 which define a scale that is centred on and extends around a scale axis B. The scale features 106 are formed on a planar surface 105 of the disc scale member 102, and as shown, the scale axis B extends normal to the planar surface 105. Note that the scale axis B may, or may not, be coincident with the geometric centre the disc scale member 102/planar surface 105. During use, a readhead 110 can be positioned so as to read the scale features 106 so as to determine and report to an external device relative motion between the disc scale 102 and the readhead.

The disc scale member 102 also comprises on its planar surface 105 an alignment band 108 which is formed concentrically with respect to the scale (i.e. the alignment band 108 is also centred on and extends around the scale axis B). The offset between the axis of rotation A and the scale axis B can be determined by a sensor 112, for example an optical sensor, which monitors the radial position of the alignment band as the disc scale member 102 and the shaft 104 rotate. Any offset between the axis of rotation A and the scale axis B will cause the alignment band to move radially back and forth with rotation. An operator can then use the output of the sensor 112 to determine how to adjust the radial position of the disc scale member 102 relative to the shaft 104 so as to reduce the offset. When the operator is happy that the offset is sufficiently small then the operator can fix the radial position of the disc scale member 102 relative to the shaft 104, e.g. via bolts, clamps and/or adhesive. In alternative known solutions, rather than providing and monitoring the radial position of an alignment band, a sensor (e.g. 112) can look at the edge of the scale lines to monitor their radial position as the disc scale rotates, from which the offset between the axes A and B can be determined. Alternatively, a pair of readheads could be configured to read the scale features and any offset of the axes A and B can be determined from the count difference between the pair of readheads.

The present invention relates to an improved technique for determining any offset between the axis of rotation and the scale axis of a disc scale member.

According to a first aspect of the invention there is provided a method of determining any offset (e.g. determining eccentricity) between: a) a scale axis of a disc scale member having a planar surface on which is provided a series of scale features defining a scale that extends and is centred around the scale axis, the scale axis extending normal to the planar surface; and b) the axis of rotation of a machine part on which the disc scale member is mounted, wherein the axis of rotation and the scale axis of the disc scale member are substantially parallel, the method comprising: i) determining any offset (e.g. determining eccentricity) between the scale axis and the axis of rotation via inspection of an axially-extending surface provided with the disc scale member (in other words, via inspection of an axially-extending surface of the disc scale member).

Determining any offset (e.g. determining eccentricity) (e.g. determining merely the presence of, and/or determining a value representative of the extent and/or angle/phase/orientation of the offset/eccentricity) between the scale axis and the axis of rotation via inspection of an axially-extending surface of a reference feature provided with the disc scale member has been found to provide a particularly convenient way of determining any offset (e.g. determining eccentricity). In particular, it can enable the use of inspection tools which are typically low-cost and readily available to those installing disc scales. It can also avoid the need to form an alignment band on the disc scale member during the manufacture of the disc scale. Furthermore, the method of the invention can aid installation of the disc scale member in dirty environments (and/or reduce the chance of scale damage) because the reading face of the scale (i.e. the planar surface on which the scale features are provided) can be protected during installation and any offset between the scale axis and axis of rotation can be determined by inspecting an axially-extending surface, rather than the reading face of the scale which would be difficult/not possible if it is covered to protect it.

The scale features could be radially-extending scale features. For example, the scale features could be elongate in the radial direction, e.g. each scale feature could comprise a line which extends radially, (with respect to the scale axis). The scale can extend annularly around the scale axis. The scale can extend continuously annularly around the scale axis. The scale could comprise an incremental scale. The scale could comprise one or more reference marks. The scale could comprise an absolute scale. The scale could comprise optical, capacitive, inductive and/or magnetic scale features. The scale can comprise one or more tracks of scale features.

The method can further comprise: ii) adjusting the radial position of the disc scale member based on the offset (e.g. eccentricity) determined in step i). This could be, for example so as to reduce the offset (e.g. eccentricity) between the scale axis and the axis of rotation. Step ii) can comprise manually adjusting the radial position of the disc scale member. Alternatively, the radial position of the disc scale member could be adjusted via an automatic process, e.g. via a servo-controlled machine/robot.

Additionally or alternatively, the method could further comprise: iii) using the determined offset (e.g. eccentricity) to compensate for offset-related errors in the signals obtained by a readhead mounted to read the scale. For example, an error function and/or map (e.g. look-up table) could be created from the determined offset (e.g. eccentricity) and used during subsequent reading of the scale so as to correct a reading of the scale obtained by the readhead. The readhead itself could be configured to correct the reading of the scale before it outputs a signal to an external device, or an external device (e.g. an interface unit or a controller) could be configured to correct the signal output by the readhead, e.g. using said error function and/or map.

The axially-extending surface could comprise an outer (e.g. the outermost) perimeter/edge (e.g. circumferential edge) of the disc scale member. The axially-extending surface/the outer perimeter could be provided on the same substrate/body as that on which the scale features are provided. Alternatively, the axially-extending surface/the outer perimeter could be provided on a different substrate/body. For instance, the axially-extending surface/the outer perimeter could be provided on a hub which is formed separately to the substrate/body on which the scale features are provided, but on which the substrate/body on which the scale features are provided is mounted.

The axially-extending surface can extend and be centred around a reference axis that is parallel to the scale axis. The axially-extending surface could extend annularly around the reference axis. The axially-extending surface could extend continuously annularly around the reference axis. In advantageous embodiments of the invention, the axially-extending surface has a substantially constant radius around the reference axis. Accordingly, in advantageous embodiments of the invention the axially-extending surface has a substantially circular cross-sectional shape. The axially-extending surface could extend substantially parallel to the scale/reference axis. In other words, the axial extent of the axially-extending surface could extend substantially parallel to the scale/reference axis. For example, the axially-extending surface could have a substantially cylindrical form. As will be understood, in other embodiments, the axially-extending surface might not extend substantially parallel to the scale/reference axis. For example, the axially-extending surface could have a substantially conical form.

The axially-extending surface could be described as being provided on a reference feature, which is provided with the disc scale member. Optionally, the reference feature comprises the substrate/body providing the planar surface on which the scale features are provided. Accordingly, in such a case, the axially-extending surface could comprise an outer (e.g. the outermost) perimeter (e.g. circumferential edge) of the disc scale, for example. Optionally, the reference feature is provided on the substrate/body providing the planar surface, e.g. the reference feature could comprise an upstand feature on the planar surface. Optionally, the reference feature is provided separately to the body/substrate providing the planar surface, e.g. the reference feature could be provided on a hub onto which the substrate/body providing the planar surface is mounted. In any case, the reference feature could itself extend and be centred around the reference axis.

Inspecting the axially-extending surface in step i) can comprise using an inspection tool/sensor (e.g. to obtain radial position measurements of the axially-extending surface as described below). The inspection tool/sensor could comprise a contact tool/sensor which contacts the axially-extending surface (e.g. to obtain such measurements). The inspection tool/sensor could comprise a non-contact tool/sensor (e.g. which obtains such measurements without contacting the axially-extending surface).

Inspecting the axially-extending surface in step i) can comprise measuring the change in apparent radius of the axially-extending surface (e.g. of the reference feature) at at least three, different annularly spaced locations (i.e. different spaced locations around the axis), preferably at at least four different annularly spaced locations. Such measurements at different annularly spaced locations can be obtained by keeping the inspection tool/sensor at a fixed rotational position about the axis of rotation A, and rotating the disc scale member about the axis of rotation A so that the inspection tool/sensor can obtain measurements at the different annularly spaced locations of the axially-extending surface.

The above-described inspection/measurements could be performed/taken whilst the disc scale member is rotating, or could be performed/taken when the disc scale member is stationary.

Preferably, the scale axis and the reference axis are substantially coaxial. This can make it easier to determine the offset between the scale axis and the axis of rotation from the inspection of the axially-extending surface.

The disc scale member can comprise a metallic disc scale member. However, this need not necessarily be the case. For example, optionally, the disc scale member comprises a glass disc scale member.

The disc scale member can comprise at least one, optionally at least two, preferably at least three, for example four or more (mounting) radially compliant flexures. The at least one radially compliant flexure could be provided on a member (e.g. a hub) which is formed separately from, but attached to, the body/substrate of the disc scale member on which the scale is provided. However, preferably the at least one radially compliant flexure(s) is(are) integrally formed on the body/substrate of the disc scale member on which the scale is provided.

For instance, the body/substrate of the disc scale member on which the scale is provided, and the at least one radially compliant flexure can be formed from a single piece of material. This can be advantageous, especially for thin planar scale disc members, as it can help to ensure the compactness of the scale disc member, as well as help to ensure that the flexures are contained within the same plane as the body/substrate of the disc scale member on which the scale is provided.

The method can comprise push/force fitting the disc scale member and the machine part together, whereby the at least one flexure is displaced by the machine part and thereby urges the disc scale member (via a radial reaction force) into engagement with the machine part so as to form a friction fit with the machine part such that the disc scale member self-locates at an initial default/predetermined radial location with respect to the machine part and then determining any offset between the scale axis and the axis of rotation via inspection of an axially-extending surface provided with the disc scale member. However, this need not necessarily be the case and the disc scale member can at least initially have a radial loose fit on the machine part, in which case its initial radial location will be that at which the operator/installer initially placed the disc scale member. Either way, step ii) can comprise tweaking (in other words “adjusting”, or “fine-tuning”) the radial location of the scale disc member relative to the machine part away from its initial (e.g. default/predetermined) radial location to a new radial location.

According to another aspect of the invention there is provided a method of determining any offset between: a) a scale axis of a disc scale member having a planar surface on which is provided a series of scale features defining a scale that extends and is centred around the scale axis, the scale axis extending normal to the planar surface; and b) the axis of rotation of a machine part on which the disc scale member is mounted, wherein the axis of rotation and the scale axis of the disc scale member are substantially parallel, the method comprising: i) determining any offset between the scale axis and the axis of rotation via inspection of a substantially cylindrical surface or a substantially conical surface (e.g. outer edge) of the disc scale member. The features described above in connection with the first aspect of the invention are also applicable to this aspect of the invention. Accordingly, the substantially cylindrical surface or a substantially conical surface can comprise the above-described reference feature.

For example, inspecting the substantially cylindrical surface or a substantially conical surface in step i) can comprise measuring the change in apparent radius of the substantially cylindrical surface or a substantially conical surface (e.g. of the reference feature) at at least three, different annularly spaced locations (i.e. different spaced locations around the axis), preferably at at least four different annularly spaced locations.

According to another aspect of the invention there is provided a method of determining any offset between: a) a scale axis of a disc scale member having a planar surface on which is provided a series of scale features defining a scale that extends and is centred around the scale axis, the scale axis extending normal to the planar surface; and b) the axis of rotation of a machine part on which the disc scale member is mounted, wherein the axis of rotation and the scale axis of the disc scale member are substantially parallel, the method comprising: i) determining any offset between the scale axis and the axis of rotation via inspection of an outer (e.g. the outermost) perimeter/edge (e.g. circumferential edge) of the disc scale member. The features described above in connection with the first aspect of the invention are also applicable to this aspect of the invention. Accordingly, the outer perimeter/edge can comprise the above-described reference feature. For example, inspecting the outer perimeter/edge in step i) can comprise measuring the change in apparent radius of the outer perimeter/edge (e.g. of the reference feature) at at least three, different annularly spaced locations (i.e. different spaced locations around the axis), preferably at at least four different annularly spaced locations.

According to another aspect of the invention there is provided a method of manufacturing a disc scale member, comprising the step of forming on a planar surface of the disc scale member a series of scale features which define a scale that extends and is centred around a scale axis that extends normal to the planar surface, wherein the forming process is controlled such that the scale axis is coaxial with a reference axis about which an axially-extending surface that is provided with the disc scale member extends and is centred around. Manufacturing a scale in this way means that the scale axis can be found easily by an operator/installer by simply measuring the axially-extending surface that is provided with the disc scale member. The features described above in connection with the first aspect of the invention are also applicable to this aspect of the invention. In particular, for example, it can be preferred that the axially-extending surface is an outer (e.g. the outermost) circumferential surface of the disc scale member, for example an outer (e.g. the outermost) circumferential surface of the substrate on which the scale features are formed.

Embodiments of the invention will now be described, by way of example only, with reference to the following drawings, in which:

FIGS. 1a and 1b are plan and side views of a prior art configuration for determining the offset between a scale axis of a disc scale member and the axis of rotation of the machine part on which the disc scale member is mounted;

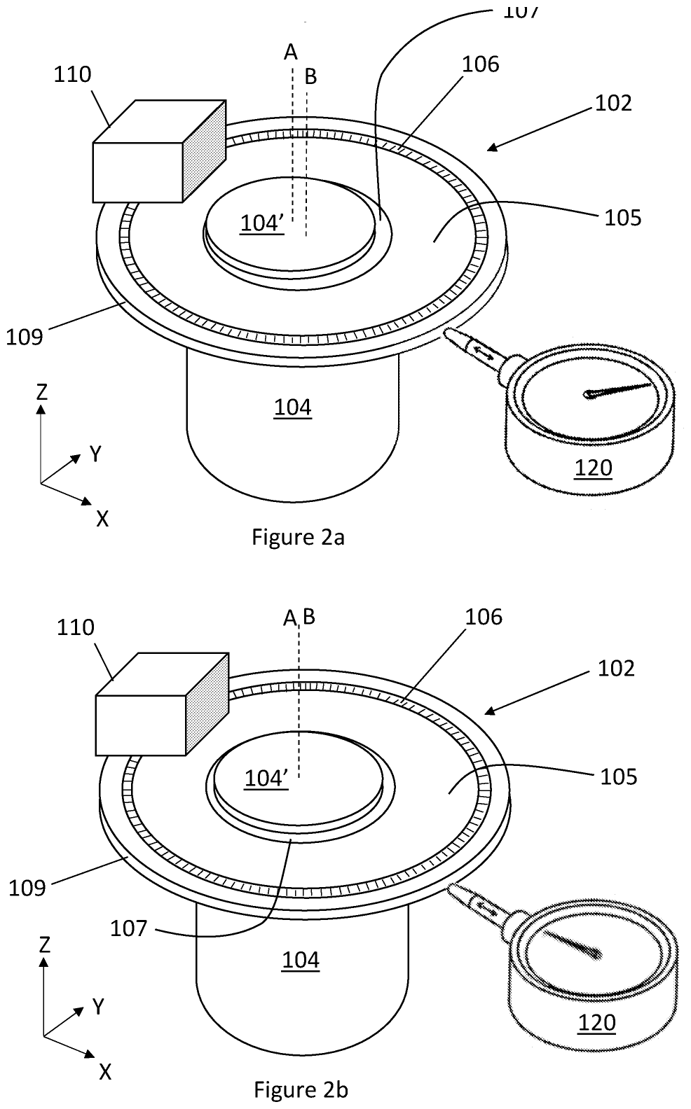

FIGS. 2a and 2b are isometric views of a configuration for determining the offset between a scale axis of a disc scale member and the axis of rotation of the machine part on which the disc scale member is mounted, in accordance with a first embodiment of the present invention;

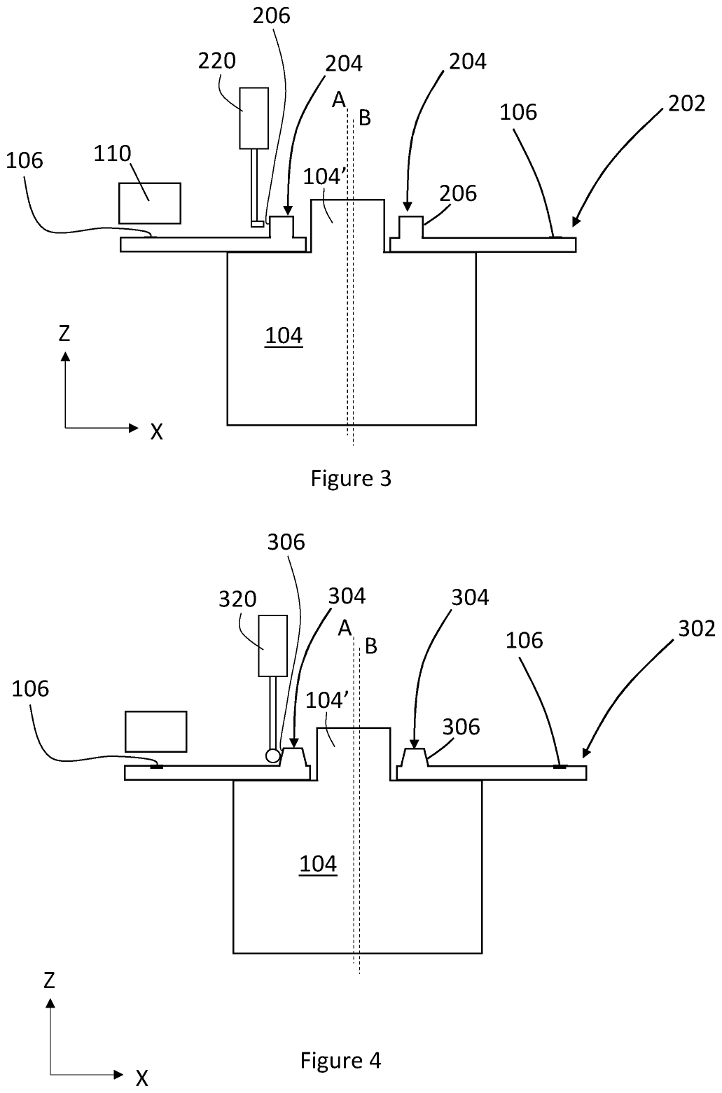

FIG. 3 is a side cross-sectional view of a configuration for determining the offset between a scale axis of a disc scale member and the axis of rotation of the machine part on which the disc scale member is mounted, in accordance with a second embodiment of the present invention;

FIG. 4 is a side cross-sectional view of a configuration for determining the offset between a scale axis of a disc scale member and the axis of rotation of the machine part on which the disc scale member is mounted, in accordance with a third embodiment of the present invention;

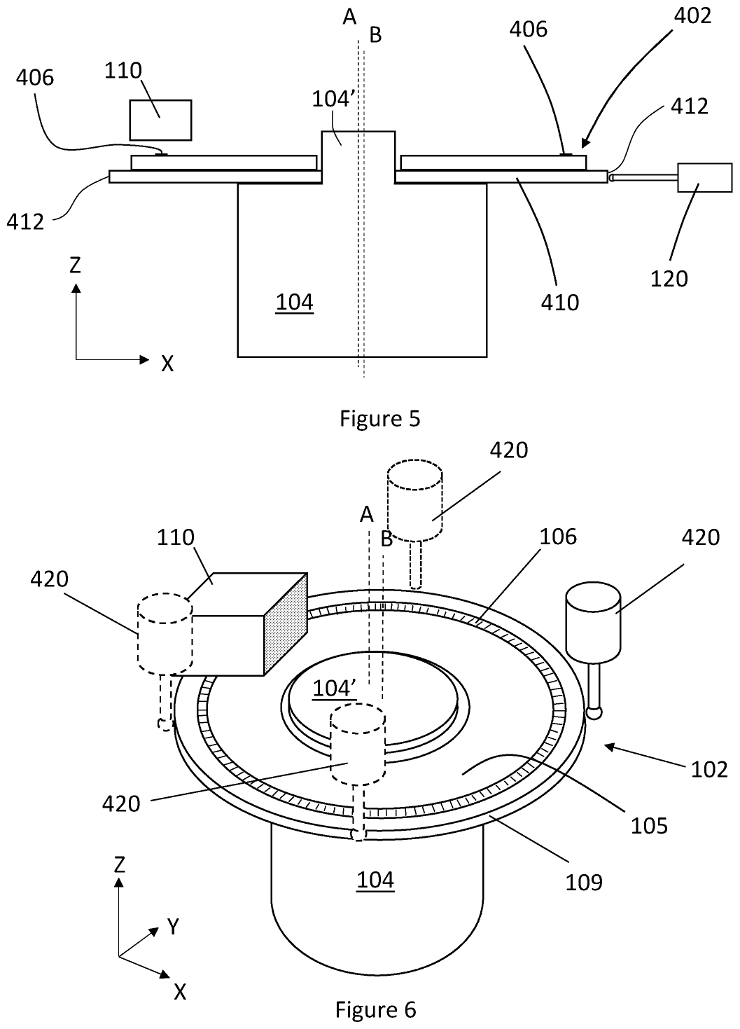

FIG. 5 is a side cross-sectional view of a configuration for determining the offset between a scale axis of a disc scale member and the axis of rotation of the machine part on which the disc scale member is mounted, in accordance with a third embodiment of the present invention;

FIG. 6 is an isometric view of a configuration for determining the offset between a scale axis of a disc scale member and the axis of rotation of the machine part on which the disc scale member is mounted, in accordance with a fourth embodiment of the present invention;

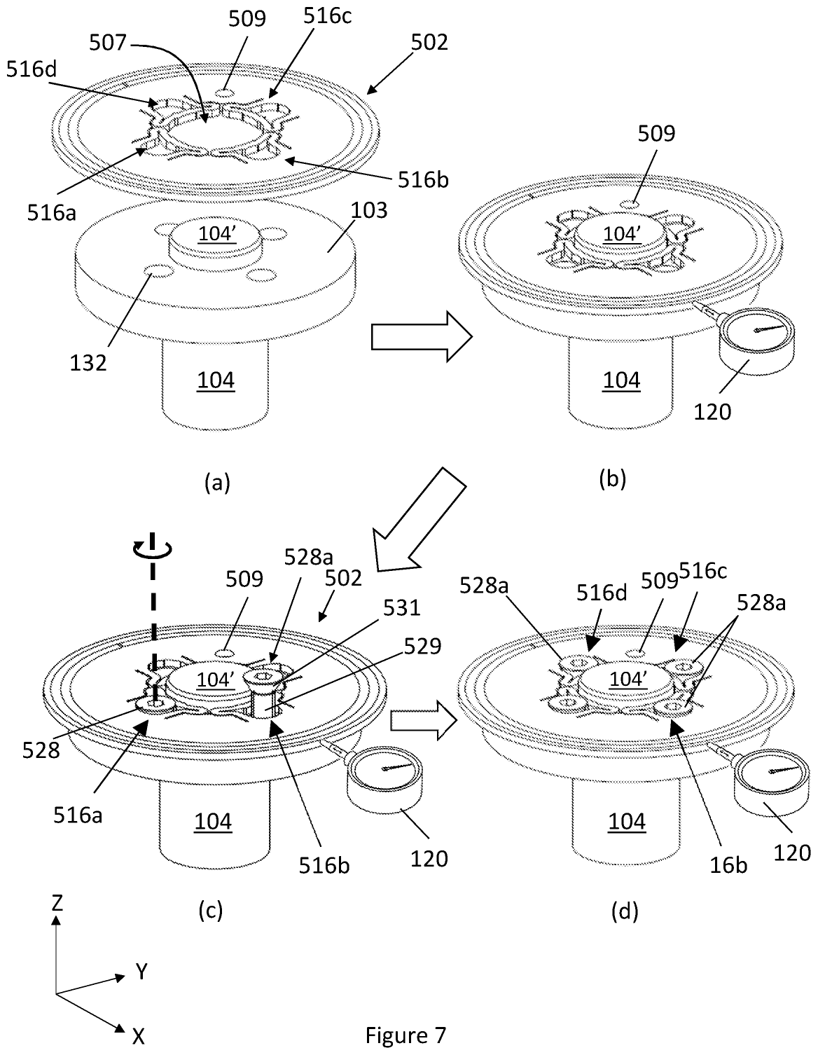

FIGS. 7a to d are isometric views of a configuration for determining and adjusting the offset between a scale axis of a disc scale member and the axis of rotation of the machine part on which the disc scale member is mounted, in accordance with a fifth embodiment of the present invention; and

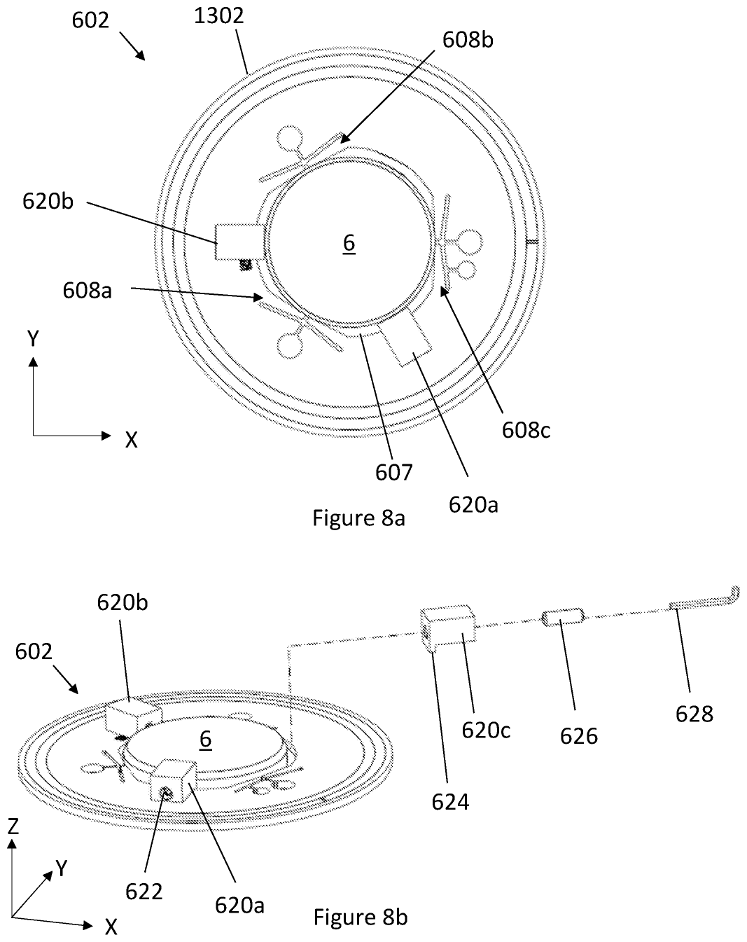

FIGS. 8a and 8b are plan and isometric views of a disc scale member configuration which is adjustable via nudge blocks.

Referring to FIG. 2a, there is shown a disc scale member 102 which has been mounted on a rotary part 104 of a machine (not shown) which is configured to rotate about an axis of rotation labelled A in FIG. 2a. The disc scale member 102 comprises a series of scale features 106 which define a scale that is centred on and extends continuously annularly around a scale axis labelled B in FIG. 2a. Accordingly, as shown, the scale is substantially circular in shape and has a constant radius around the scale axis. The scale features 106 are formed on a planar surface 105 of the disc scale member 102, and as shown, the scale axis B extends normal to the planar surface 105. In the embodiment shown, the planar surface 105 is provided by a planar body/disc having a circular outer perimeter/circumferential edge. The scale features 106 are “radially-extending” in that each feature extends in a radial direction. Accordingly, the scale features 106 are not parallel to each other but rather fan-out in a radial direction. During use, a readhead 110 can be mounted to another part of the machine (not shown) and positioned so as to read the scale features 106 so as to be able to determine and report to an external device relative motion between the disc scale 102 and the readhead 110.

In the example shown, the disc scale member 102 is shown mounted on a cylindrical shaft 104 of a machine. The disc scale member 102 comprises a planar body, and in particular, the disc scale member 102 is formed from a thin sheet of material, in this embodiment, from stainless steel, which is about 1 mm thick. For context, the diameter of the disc scale member 4 in this embodiment is about 50 mm. As will be understood, the invention is not limited to discs of such a size or shape, and such dimensions are given merely as an example of a disc. Also, the disc scale member could be made from other metallic materials, such as aluminium, or non-metallic materials such as glass.

In the embodiment described, the disc scale member has a central hole 107 extending through the planar body of the disc scale member 102, and the diameter of the central hole 107 oversized such that it is larger than the part 104′ of the shaft which extends through the hole 107. This means that there is a sufficiently large play between the disc scale member 102 and the part 104′ of the shaft so as to enable the radial position of the disc scale member 102 to be adjusted. As will be understood, other configurations are possible, including discs which do not have a central hole and/or the disc scale member 102 could be mounted on a flat end face of the machine/rotary part 104 (e.g. there might not be a protruding part 104′).

As shown in FIG. 2a, the disc scale member 102 has been mounted on the rotary part 104 of the machine at an initial radial location where the scale axis B is offset from the axis of rotation A. In accordance with the present invention, the offset is measured by the use of a sensor, in this embodiment a dial test indicator (DTI) 120, which inspects/interacts with the axially-extending outer circumferential surface 109 of the disc scale member 102. In one embodiment, the DTI 120 continuously inspects the axially-extending outer circumferential surface 109 of the disc scale member 102 as it rotates around at least one full revolution, and a Fourier Transform (e.g. a Discrete Fourier Transform or Fast Fourier Transform) of the DTI's output from the full scan of at least revolution can be performed. In this embodiment it is known that the geometric central axis of the axially-extending outer circumferential surface 109 is coaxial with the scale axis B, and therefore the magnitude of the fundamental (spatial) frequency obtained by the Fourier Transform is directly indicative of the magnitude of the offset of scale axis B relative to the axis of rotation A. Also, the phase of the fundamental (spatial) frequency is directly indicative of the rotational position of the offset around the axis of rotation A. Therefore, the phase and magnitude of the fundamental (spatial) frequency obtained by the Fourier Transform can be used to determine a vector representing the offset of the axes A and B. Accordingly, the operator can use the phase and magnitude of the fundamental frequency (i.e. the vector representing the offset) obtained by the Fourier Transform to determine by how much and in what direction to adjust the radial position of the disc scale member so as to reduce the eccentricity/offset of the axes. Alternatively, this information can be used to create an error map. For example, an error function and/or map (e.g. look-up table) could be created from the determined offset/eccentricity vector and used during subsequent reading of the scale so as to correct the output of the readhead (e.g. either before or after the measurement signal leaves the readhead).

In another embodiment, the offset (e.g. eccentricity) of the scale axis B and axis of rotation A can be determined from the output of the DTI 120 taken at at least three circumferentially spaced locations, and preferably taken at at least four circumferentially spaced locations, which are preferably equiangular locations around the circumference. The measurements could be taken whilst the disc scale member is rotating or stationary.

Rather than calculating an exact value of the offset between axes A and B, the existence of the offset, and information regarding the extent of the offset, can be determined by an operator simply monitoring the output of a DTI 120 which is held at a rotationally fixed position as the disc scale member is rotated. Variation in the output of the DTI at different locations around the circumference of the disc scale member 102 indicates that there is an offset between axes A and B, and the extent of the offset will affect the extent of the variation in the output of the DTI 120 at different circumferential locations. The operator could use such information to judge how to adjust the radial position so as to reduce the offset. Once adjusted, the operator could check for any remaining offset by rotating the disc scale member 102 and again monitoring the output of the DTI 120 as the disc scale member is rotated.

In another embodiment, the operator could use the DTI 120 to take measurements of the axially-extending surface of the disc scale member 102 at a different (stationary) rotational orientations, e.g. with the disc scale member 102 arranged at 0°, 120° and 240° about the axis A (or for example at 0°, 90°, 180° and 270° about the axis A). If there is any difference between the measurements the operator can deduce that there is an offset between the axis of rotation A and the scale axis B and adjust the radial position of the scale disc member 102 so as to minimise the difference in the readings provided by the DTI 120 at those different rotational orientations. If the axially-extending surface of the disc is not perfectly circular, then it can be beneficial for the DTI measurements to be obtained at the same points which were used by the manufacturer to take measurements for aiding centring of the disc prior to forming the scale makings. Such points could be marked on the disc by the manufacturer, e.g. fiducials could be placed at the locations used by the manufacturer.

When the operator is happy that the offset is sufficiently small then the operator can fix the radial position of the disc scale member 102 relative to the shaft 104, e.g. via bolts, clamps and/or adhesive.

In the embodiment described, the DTI 120 shown comprises an analogue display, but as will be understood this need not necessarily be the case and the DTI could comprise a digital display. Furthermore, as will be understood, it is not necessary to use a DTI to determine the offset; a different type of sensor could be used. Example suitable sensors for determining the offset include: a capacitance probe, a laser probe, a linear variable differential transformer (LVDT). Accordingly, a contact sensor could be used, or a non-contact sensor could be used. As with the above described DTI 120, the output of the sensor could be shown on a display which is provided with the sensor unit, or alternatively/additionally the sensor could send its output to a separate device/software which can display the output and/or store and/or process the output accordingly (e.g. to automatically adjust the radial position, to indicate to an operator how to adjust the radial position of the disc scale member, and/or to store the offset for subsequent error correction purposes, as explained in more detail below).

In the embodiments described above, it is assumed that the scale axis B and the geometric axis about which the outer perimeter/circumferential surface 109 (which in this embodiment, is the outermost perimeter/circumferential surface) of the disc scale member 102 is centred on and extends around are co-axial. Manufacture of the disc scale member 102 can be configured so as to ensure that this is case. However, this need not necessarily be the case. For instance, the scale axis B and the geometric axis about which the outer circumferential surface 109 of the disc scale member 102 is centred on and extends around could be offset/eccentric. In such a case, so long as the offset/eccentricity between the scale axis B and the geometric axis about which the outer circumferential surface 109 of the disc scale member 102 is centred on and extends around is known, the outer circumferential surface 109 of the disc scale member 102 can still be used to determine the scale axis B. For instance, the phase and magnitude of the eccentricity/offset values obtained using the methods described in connection with the above-described embodiments will provide a measured vector that is the total combined eccentricity of i) the scale relative to the axially-extending surface and of ii) the axially-extending surface relative to the axis of rotation. If the scale to axially-extending surface vector is known (e.g. this could be established by the manufacturer and provided to the customer, or they could measure it themselves), then the scale to axis of rotation vector can be calculated by subtracting the known vector from the measured vector. US2008189934 also describes additional/alternative techniques which could be used to determine the offset between the scale axis B and the axis of rotation when there is a known offset between the geometric axis and the scale axis B.

In the embodiment described, the DTI 120/displacement sensor interacts with/inspects the outer perimeter/circumferential surface 109 of the disc scale member 102. However, this need not necessarily be the case; for instance the DTI 120/displacement sensor could interact with/inspect another axially-extending surface provided with the disc scale member 102. For example, with reference to FIG. 3, there is shown a disc scale member 202 which comprises a ring-shaped upstand 204 having an axially-extending outer circumferential cylindrical surface 206 which is centred on and extends annularly around the scale axis B (but similar to that described above in connection with FIG. 2, the axis about which the axially-extending outer circumferential cylindrical surface 206 of the upstand part 204 is centred on and extends around could be offset from the scale axis B). In this embodiment, a non-contact sensor 220, for example a capacitance sensor, is used to inspect/interact with the axially-extending outer circumferential cylindrical surface 206 of the upstand part 204 so as to determine the offset between the scale axis B and the axis of rotation A.

FIG. 4 illustrates another embodiment which is similar to the embodiment of FIG. 3 in that the disc scale member 302 of FIG. 4 comprises a ring-shaped upstand 304 having an axially-extending outer circumferential conical surface 306 which is centred on and extends around could be offset from the scale axis B, but differs from the embodiment of FIG. 3, in that the axially-extending outer circumferential cylindrical surface 306 does not extend parallel to the scale axis/axis of rotation, but nevertheless does have sufficient axial extent in the axial direction for a sensor (in the embodiment shown in FIG. 4, a contact displacement sensor 320) to inspect/interact with the axially-extending circumferential surface 306 so as to measure radial deviations thereof at different rotational positions around the axis of rotation. As will be understood, in the embodiments of FIGS. 3 and 4, the sensor 220, 320 could be arranged to inspect the opposing, inner surface of the upstand feature 204, 304, but it is usually more convenient to inspect the outer surface of the upstand feature.

In the embodiments described above, the sensor inspects/interacts with a part of the disc scale member which has been integrally formed with the part of the disc scale member on which the scale features are provided (i.e. the surface of the part inspected by the sensor and the part on which the scale features are provided are a single piece). However, this need not necessarily be the case. For example, as shown in FIG. 5, the disc scale member 402 on which the scale features 406 are provided could be mounted to a hub 410 which is formed separately to disc scale member 402 on which the scale features 406 are provided. The disc scale member 402 and the hub 410 can be formed from different materials. In this embodiment, the sensor, e.g. a DTI 120, is configured to inspect an axially-extending surface provided on the hub 410, e.g. as shown in this embodiment its outermost circumferential surface 412. In such a case, preferably the scale axis B is co-axial with the axis about which the axially-extending circumferential surface 412 is centred on an extends around. If not, then as explained above, knowledge of the offset between the scale axis B and the axis about which the axially-extending circumferential surface 412 is centred can be used to determine the offset between the scale axis B and the axis of rotation A by inspecting/interacting with the axially-extending circumferential surface 412.

In the embodiments described above, the sensor 120, 220, 320, is held stationary and the disc scale member 102 is rotated, and the output of the sensor is used to determine radial position of the axially-extending circumferential surface at a plurality of different rotational positions of the disc scale member 120, from which the offset between the scale axis B and the axis of rotation A can be determined. In an alternative embodiment, the disc scale member 102 (and the shaft 103/rotary part of the machine) is held still, and measurements of the radial position of the axially-extending circumferential surface are taken at different circumferential positions. For example, as shown in FIG. 6, a measurement probe 420 can be moved to different positions around the disc scale member 102 at which a measurement of the radial position of the axially-extending outer circumferential surface 109 is obtained, from which the offset between the scale axis B and the axis of rotation A can be determined. In such an embodiment, the measurement probe 420 could be mounted on a positioning apparatus, such as a coordinate measuring machine (CMM), for instance a robot arm or portal-type CMM. Furthermore, if the axis of rotation A is not already known, the method can comprise measuring the shaft 104, e.g. using the same measurement probe 420, in order to determine the axis of rotation A. This assumes that the axis of rotation A is coaxial with the geometric centre of the shaft 104. (If such an assumption cannot be made, then the axis of rotation A could be established by taking measurements of the shaft 104 at different rotational positions).

In the embodiment described the disc scale member 102 comprises optical scale features 106, but this need not necessarily be the case. For instance, the disc scale member 102 could comprise magnetic, inductive or capacitive scale features. Furthermore, in the embodiment described, the readhead 110 and disc scale member 102 are configured to work via reflection of light from the disc scale member 102 (in that the light from the readhead 110 is reflected by the scale back toward the readhead, and in that the readhead's illumination and scale detection components are on the same side of the scale). However, this need not necessarily be the case, and the readhead 110 and disc scale member 102 could be configured to work via transmission of light from the disc scale member 102 (in which case the readhead's light source and sensor could be on opposite sides of the disc scale member 102).

In this embodiment, the disc scale member 102 is an incremental scale disc and the scale features 106 comprise a series of periodically arranged features which the readhead 110 can read in order to provide a count of the relative position/movement of the scale disc 4 and the readhead 10. As is common in the field of incremental encoder apparatus, the disc scale member 102 could comprise one or more reference marks which can be read by the readhead 110 when it passes the readhead, so that the readhead 110 can identify a reference position on the disc scale member 102. Of course, the disc scale member 102 could be an absolute scale disc, in which case the scale features 106 can be arranged so as to define a series of unique absolute positions such that the absolute position of the disc scale member 102 and readhead 110 can be determined on start-up without requiring relative motion of the disc scale member 102 and the readhead 110.

In the embodiment described above, the disc scale member has a central hole 107. As will be understood, in other embodiments, the disc scale member 102 might not have a central hole and/or it might be that there isn't a part 104′ of the shaft which extends through the disc scale member 102.

Furthermore, in another embodiment, the disc scale member 102 might have one or more radially resilient members (e.g. flexures, for instance integral flexures) located around the inner circumference of the central hole 107 which are configured to engage the part 104′ of the shaft extending through the central hole. Such radially resilient members could be configured such that the inner diameter defined by the radially resilient members is smaller than the diameter of the part 104′ of the shaft so that they are radially displaced when the disc scale member 102 is mounted on the shaft 104, thereby causing the disc scale member to automatically adopt an initial default radial position. Examples of such embodiments are depicted in FIGS. 7 and 8.

In the embodiments described above in connection with FIGS. 2 to 6, radial adjustment takes place by an operator sliding the disc scale member 102, 202, 302, 402 relative to the shaft/rotary part 104 of the machine. This could be done, for example, by bare hand, or by using a tool which the operator manipulates manually, or by an automated device (e.g. a robot arm) effecting such adjustment on the basis of the output of the sensor 120, 220, 320. FIG. 7 shows an example configuration for aiding radial adjustment of a disc scale member 502 relative to the shaft 104. The disc scale member 502 comprises a plurality of flexures 516a, 516b, 516c, 516d configured to engage the part 104′ of the shaft extending through a central hole 507 in the disc scale member 502. The flexures 516 are shaped and sized such that the effective diameter of the hole 507 is slightly smaller than the diameter of the part 104′ of the shaft onto which it is to be mounted, in this embodiment by approximately 20-40 μm. The flexures 516 are resiliently compliant in the radial direction. Accordingly, the flexures 516 could be referred to as “radial spring members”. Due to the effective diameter of the hole 507 being slightly smaller than the diameter of the part 104′ of the shaft onto which it is to be mounted, the disc scale member 502 has to be force fitted onto the part 104′ of the shaft. Accordingly, once the disc scale member 502 has been forced onto the part 104′ of the shaft, there is a natural/default/automatic tight fit between them. This is because the process of force fitting the disc scale member 502 onto the part 104′ of the shaft causes the flexures 516 to radially deflect, wherein the elasticity of the material of the flexures 516 causes a reaction force on the part 104′ of the shaft. This causes them to be biased into the part 104′ of the shaft along the radial direction, so as to thereby engage, and radially locate the disc on, the shaft 6 (at a predetermined/default radial location).

On the assumption that the four flexures 516 are nominally identical, they should ensure that disc scale member 502 is nominally centred on the part 104′ of the shaft—in other words, the action of force fitting the disc scale member 502 on the part 104′ of the shaft should cause the disc scale member to “self-centre” on the part 104′ of the shaft. However, relying on the self-centring ability of the disc scale member 502 might not be sufficient, and/or the actual axis of rotation A might be different from the physical central axis of the part 104′ of the scale. Accordingly, even with such self-centring ability it might be advantageous to be able to determine the offset between the scale axis B and the axis of rotation A.

As schematically illustrated in steps (a) to (d) of FIG. 7, an operator can begin installing the scale disc member 502 onto the shaft 104 by approximately aligning the scale disc member 502 such that it is substantially co-axial with the part 104′ of the shaft, and then pushing the scale disc member 502 onto the part 104′ of the shaft, substantially along the axial direction, such that the part 104′ of the shaft protrudes through the hole 507 in the scale disc member 502. In this embodiment, the installer keeps pushing scale disc member 502 along the part 104′ of the shaft until the underside of the scale disc member 502 comes to rest on a ledge 103, as shown in step (b) of FIG. 7.

The installer can then check the radial position of the scale disc member 502 at step (b). In line with the above-described embodiments, this could be achieved mechanically, for example using a Dial Test Indicator (DTI) 120 on an outer edge of the disc as it is rotated. Optionally, a non-contact, e.g. optical method could be used. If as a result of this step an offset between the scale axis B and the axis of rotation A is determined, then the installer can fine tune the radial position of the scale disc member 502 at step (c). This is achieved in this embodiment via the use of one or more adjustment bolts 528. An adjustment bolt 528 comprises a threaded portion 529 and a tapered head 531. As shown, a first adjustment bolt 528 can be received through the void of a first flexure 516a, such that a threaded portion of the adjustment bolt is received within a threaded hole 132a in the ledge 103 of the shaft 104. As per a normal threaded member, the adjustment bolt 528a can be rotated so as to change its axial position. Accordingly, as the adjustment bolt 528a is further rotated to cause it to penetrate further into the threaded hole 32, the tapered head 31 will push against flexure 516a with increasing force. In view of that the flexure 516a is butted up against the part 104′ of the shaft 104, the flexure 516a is fixed in place and cannot move, and so the tapered head 31 will cause the main annular body of the disc scale member 502 to move (in this example in the Y-dimension).

When the annular body 5 is in the desired radial position, then as illustrated in step (d) of FIG. 7, the adjustment bolt 528 can be left in place so as to hold the disc scale member 502 in position. Also, in this case, as shown in Figures (c) and (d), it can be advantageous to locate further bolts 528a (which could be identical to the adjustment bolts 528) in the voids of the other flexures (516b, 516c, 516d) such that they help to clamp the scale disc member 502. If so, then it is desired that they are not over tightened because doing so will cause the flexures (516a, 516b, 516c, 516d) to fight one another and/or distort the annular body. Additionally (or alternatively), the radial position of the disc scale member 502 could be fixed in place by other means, such as adhesive and/or a different mechanical fastener. For instance, one or more supplemental fastener hole(s) 509 could be provided on the disc scale member 502 through which a fastener such as a clamping bolt can be passed and secured to the shaft (e.g. via a hole in the ledge 103), so as to clamp the disc scale member 502 in place. The bolt(s) 528(a) could then be removed.

FIGS. 8a and 8b illustrate an alternative embodiment. Similar to the other embodiments described above, the disc scale member 602 of this embodiment comprises a planar, annular body on which a scale features are provided on one of its planar faces, and a hole 607 through its middle through which the part 104′ of the shaft 104 can extend when the disc scale member is mounted thereon. The disc scale member 602 comprises three pairs of radially compliant cantilevered spring members 608a, 608b, 608c which are provided in plane with the planar disc scale member and are spaced equidistantly around the edge of the hole 607. A flexure void is provided directly behind each pair of cantilevered spring members.

Similar to embodiment of FIG. 7, the flexure pairs 608 are shaped and sized such that the effective diameter of the hole 607 is slightly smaller than the diameter of the part 104′ shaft onto which it is to be mounted. Accordingly, the disc scale member 602 has to be force-fitted onto the part 104′ shaft, thereby causing the flexures to deflect into their respective flexure voids. Once the disc scale member 602 has been force-fitted onto the part 104′ shaft, there is a natural/default/automatic tight fit between them.

In contrast to the embodiment of FIG. 7, the flexure voids are not configured to receive an adjustment bolt via which the radial position of the disc can be adjusted. In contrast, the embodiment shown in FIG. 8a is provided with one or more nudge blocks 620a, 620b. These are rigid blocks having a threaded hole 622 extending therethrough and an abutment feature in the form of a lip 624 having a thickness which is small enough to fit in the gap between the part 104′ of the shaft and the inner edge of the hole 607 of the disc scale member 602. In order to adjust the radial position of the disc scale member 602, a nudge block 620 is placed such that its lip 624 is received in the gap between the part 104′ of the shaft and the inner edge of the hole 607 of the disc scale member 602, and then a grub screw 626 is inserted in the threaded hole 622 and tightened via a tool 628 until it engages the part 104′ of the shaft. At that point, further tightening of the grub screw 626 via the tool causes the nudge block to be pushed radially outwardly, resulting in the lip 624 pushing the disc scale member 602 radially outwards. As will be understood, in the embodiment shown two nudge blocks 620a, 620b are shown in place/in engagement with the disc scale member 602 and the part 104′ of the shaft. A third nudge block 620c is shown out of engagement with the disc scale member 620 and part 104′ of the shaft to illustrate the various parts thereof and the grub screw 626 and tool 628. It might be that only one nudge block is required to provide the desired radial adjustment. Optionally, three nudge blocks could be used if desired. As will be understood, a nudge block like that shown in FIGS. 8a and 8b could also be used to adjust the radial position of the disc scale members 102, 202, 302, 402 of FIGS. 1 to 6.

In the embodiments described above, the offset is reduced by adjusting position. For context, it is noted that in applications in which the applicant's disc scale members are likely to be used, it is unlikely that adjustments of greater than 50 μm would ever be required, and it could be that the extent of the adjustment is a small as a couple of microns. It should also be noted that the determined offset/eccentricity could be used to for error compensation purposes. For example, an error function and/or map (e.g. look-up table) could be created from the determined offset and used during subsequent reading of the scale so as to correct the output of the readhead (e.g. either before or after the measurement signal leaves the readhead).

In the embodiments described above, the axially-extending surface is provided on an annularly-extending reference feature that is centred on and extends around a reference axis that is parallel to the scale axis. In the embodiments of FIGS. 2, 6 and 7, the reference feature comprises the part/body of the disc scale member 102, 502 which provides the planar surface 105, and the axially-extending surface comprises the outer circumferential edge 109, thereof. In the embodiments of FIGS. 3 and 4 the reference feature comprises an annularly-extending upstand 204, 304 that is centred on and extends around a reference axis that is parallel to the scale axis.

In alternative embodiments, the axially-extending surface need not comprise a continuous annularly extending surface like those described above. For example, the disc scale member could comprise at least three annularly spaced, discrete, upstand features each providing an axially-extending surface which can be inspected to determine the offset. In another alternative embodiment, the outer circumferential surface of the disc scale member need not have a constant radius, but an axially-extending surface thereof can still be inspected to determine the offset between the scale axis and axis of rotation if the geometry of the outer circumferential surface is known.

1. A method of determining any offset between:
a) a scale axis of a disc scale member having a planar surface on which is provided a series of scale features defining a scale that extends and is centred around the scale axis, the scale axis extending normal to the planar surface; and
b) the axis of rotation of a machine part on which the disc scale member is mounted, wherein the axis of rotation and the scale axis of the disc scale member are substantially parallel, the method comprising:
i) determining any offset between the scale axis and the axis of rotation via inspection of an axially-extending surface of the disc scale member.

2. A method as claimed in claim 1, in which the method further comprises:
ii) adjusting the radial position of the disc scale member based on the offset determined in step i), for example so as to reduce the offset between the scale axis and the axis of rotation; or
iii) using the determined offset to compensate for offset-related errors in the signals obtained by a readhead mounted to read the scale.

3. A method as claimed in claim 1, in which the axially-extending surface is provided on the same substrate as that on which the scale features are provided.

4. A method as claimed in claim 1, in which inspecting the axially-extending surface in step i) comprises measuring the change in apparent radius of the axially-extending surface at at least three, different annularly spaced locations.

5. A method as claimed in claim 1, in which the axially extending surface extends and is centred around a reference axis that is parallel to the scale axis.

6. A method as claimed in claim 5, in which the scale axis and the reference axis are substantially coaxial.

7. A method as claimed in claim 1, in which the axially-extending surface comprises an outer perimeter of the disc scale member.

8. A method as claimed in claim 1, in which inspecting the axially-extending surface in step i) comprises using a contact inspection tool which contacts the axially-extending surface.

9. A method as claimed in claim 1, in which the disc scale member comprises a metallic disc scale member.

10. A method as claimed in claim 1, in which the axially-extending surface has a substantially circular cross-sectional shape, for example a substantially cylindrical form or a substantially conical form.

11. A method as claimed in claim 1, in which the axially-extending surface extends substantially parallel to the scale axis.

12. A method of manufacturing a disc scale member, comprising the step of forming on a planar surface of the disc scale member a series of scale features which define a scale that extends and is centred around a scale axis that extends normal to the planar surface, wherein the forming process is controlled such that the scale axis is coaxial with a reference axis of about which an axially-extending surface extends and is centred around.
